(19) United States
(12) Patent Application Publication
(10) Pub. No.: US 2008/0231607 A1
(43) Pub. Date: Sep. 25, 2008

(54) LIQUID CRYSTAL DEVICE, ELECTRONIC APPARATUS AND POSITION DETECTING METHOD

(75) Inventors: Sumio UTSUNOMIYA, Motsumoto-shi (JP); Takeshi KOSHIHARA, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/025,493

(22) Filed: Feb. 4, 2008

(30) Foreign Application Priority Data
Mar. 19, 2007 (JP) 2007-070227

(51) Int. Cl. G06F 3/041

(52) U.S. Cl. 345/173

(57) ABSTRACT

A liquid crystal device includes a liquid crystal panel, a touch panel, a position signal generating device, and a display control device. The liquid crystal panel is formed so that a liquid crystal is sealed in a gap between an element substrate and an opposite substrate, which are opposed to each other, and a transmittance ratio of the liquid crystal is controlled on the basis of a voltage applied between a first electrode and a second electrode. The touch panel is arranged on a side of the opposite substrate and provided with a plurality of detection electrodes. The position signal generating device specifies one or plurality of the plurality of detection electrodes in conformity with a predetermined rule and generates a position signal that indicates a position of a pointing body on the basis of an electric potential of the specified detection electrode or on the basis of electric potentials of the specified detection electrodes. The display control device displays an image of a fixed luminance level on a display area of the liquid crystal panel, which overlaps the detection electrode or detection electrodes specified by the position signal generating device.

### BACKGROUND

1. Technical Field

The present invention relates to a technology for identifying a position, at which an object (hereinafter, referred to as pointing body), such as a finger or a pen, contacts a display surface of a liquid crystal device, which displays an image.

2. Related Art

An existing liquid crystal device with a touch panel that uses an electrostatic capacitance method has been proposed. As described in JP-A-5-19233, JP-A-8-44493, JP-A-2000-81610 and JP-T-2003-511799, detection electrodes are formed on a viewing side of the liquid crystal device. The position of the pointing body is identified on the basis of a signal that is obtained by detecting a variation in electrostatic capacitance of the detection electrodes.

In the meantime, parasitic capacitances are formed between the detection electrodes and electrodes or wirings of the liquid crystal device. Thus, when various signals used for displaying an image vary in the liquid crystal device, there is a problem that noise is induced in the detection electrodes. Noise in the detection electrodes causes a decrease in accuracy of position identification of the pointing body.

### SUMMARY

An advantage of some aspects of the invention is that it suppresses a decrease in detection accuracy due to noise in the detection electrodes.

An aspect of the invention provides a liquid crystal device. The liquid crystal device includes a liquid crystal panel, a touch panel, a position signal generating device, and a display control device. The liquid crystal panel is formed so that a liquid crystal is sealed in a gap between an element substrate and an opposite substrate, which are opposed to each other, and a transmittance ratio of the liquid crystal is controlled on the basis of a voltage applied between a first electrode and a second electrode. The touch panel is arranged on a side of the opposite substrate and provided with a plurality of detection electrodes. The position signal generating device specifies one or plurality of the plurality of detection electrodes in conformity with a predetermined rule and generates a position signal that indicates a position of a pointing body on the basis of an electric potential of the specified detection electrode or on the basis of electric potentials of the specified detection electrodes. The display control device displays an image of a fixed luminance level on a display area of the liquid crystal panel, which overlaps the detection electrode or detection electrodes specified by the position signal generating device.

The luminance of the liquid crystal panel varies on the basis of a voltage applied between the first electrode and the second electrode, and a parasitic capacitance is formed between the first electrode and each detection electrode and is formed between the second electrode and each detection electrode. Therefore, as the luminance level to be displayed varies, the electric potentials of the first electrode and second electrode vary. Hence, the electric potentials of the detection electrodes that are capacitively coupled through the parasitic capacitances are influenced. According to the above aspect of the invention, the position of the pointing body is detected on the basis of an electric potential of the specified detection electrode or on the basis of electric potentials of the specified detection electrodes, and display of the liquid crystal panel is controlled so that a display area that overlaps the detection electrode or detection electrodes specified appears a fixed luminance level. That is, during a period when the electric potential of the specified detection electrode or the electric potentials of the specified detection electrodes are detected, it is possible to fix the electric potentials of the first electrode and second electrode. In this manner, it is possible to suppress a variation in electric potential of each detection electrode in accordance with a variation in luminance level, a position signal may be accurately generated. Note that the fixed luminance level is preferably set to a black level in terms of invisibility for a user.

Specifically, when the first electrode and the second electrode are formed on the element substrate, no electrode is formed on the first substrate, so that shielding effectiveness cannot be expected. In such a structure, a large noise voltage is superposed on the detection electrodes in accordance with a variation in luminance level; however, according to the aspect of the invention, because the luminance level is fixed, it is possible to suppress superposition of a noise voltage.

In the above described liquid crystal device, the position signal generating device may include a selection device, a detection device, and a position identification device. The selection device selects each of the plurality of detection electrodes. The detection device outputs a detection signal by detecting an electric potential of the detection electrode or detection electrodes selected by the selection device. The position identification device generates a position signal that indicates a position of the pointing body on the basis of the detection signal. The display control device determines the detection electrode or detection electrodes selected by the selection device as a detection electrode or detection electrodes specified, and displays an image of a fixed luminance level on a display area of the liquid crystal panel, which overlaps the specified detection electrode. In this case, by setting the luminance level of the display area that overlaps the selected detection electrode or detection electrodes to a fixed level, it is possible to reduce a noise voltage that is superposed on the detection electrode.

In addition, in the above described liquid crystal device, the position signal generating device may include a selection device, a detection device, and a position identification device. The selection device sequentially selects each of the plurality of detection electrodes. The detection device detects an electric potential of the detection electrode or detection electrodes sequentially selected by the selection device, and outputs a detection signal. The position identification device generates a position signal that indicates a position of the pointing body on the basis of the detection signal acquired from the detection electrode or detection electrodes specified in conformity with the predetermined rule among the detection electrodes sequentially selected by the selection device. According to the above aspect of the invention, the selection device sequentially selects the plurality of detection electrodes, and, among them, a position signal that indicates a position of the pointing body on the basis of the detection signal acquired from the detection electrode or detection electrodes specified in conformity with the predetermined rule. That is, scanning of the detection electrodes may be performed at high speed. In this case, the display area corresponding to the detection electrode or detection electrodes specified appears a fixed luminance level; however, the other display area displays an image. Then, it is possible to generate a position signal on the basis of the detection signal that is acquired from the detection electrode or detection electrodes specified and on which a noise voltage is not superposed.

Here, the plurality of detection electrodes may include a plurality of first detection electrodes that are formed parallel to a first direction and a plurality of second detection electrodes that are formed parallel to a second direction that intersects with the first direction. In a specific aspect of the invention, the liquid crystal device may be configured so that a plurality of scanning lines, a plurality of data lines and a plurality of pixels provided at positions corresponding to intersections of the scanning lines and the data lines are formed on the element substrate, and a driving device is provided to write a voltage, corresponding to a gray-scale level to be displayed, to a pixel corresponding to a selected one of scanning lines through the a corresponding one of the data lines, wherein the first direction is the same direction as a direction in which the plurality of scanning lines are formed, and wherein the second direction is the same direction as a direction in which the plurality of data lines are formed. Alternatively, the liquid crystal device may be configured so that a plurality of scanning lines, a plurality of data lines and a plurality of pixels provided at positions corresponding to intersections of the scanning lines and the data lines are formed on the element substrate, and a driving device is provided to write a voltage, corresponding to a gray-scale level to be displayed, to a pixel corresponding to a selected one of the scanning lines through the a corresponding one of the data lines, wherein the first direction and the second direction are oblique directions to a direction in which the plurality of scanning lines are formed.

Next, another aspect of the invention provides an electronic apparatus that includes the above described liquid crystal device. The above electronic apparatus includes a personal computer, a cellular phone, a personal digital assistants, and the like, which are provided with an input function using a pointing body, such as a pen or a finger.

In addition, yet another aspect of the invention provides a method of detecting a position of a pointing body in a liquid crystal device. The liquid crystal device includes a liquid crystal panel and a touch panel. The liquid crystal panel is formed so that a liquid crystal is sealed in a gap between an element substrate and an opposite substrate, which are opposed to each other, and a transmittance ratio of the liquid crystal is controlled on the basis of a voltage applied between a first electrode and a second electrode. The touch panel is arranged on a side of the opposite substrate and provided with a plurality of detection electrodes. The method includes specifying one or plurality of the plurality of detection electrodes in conformity with a predetermined rule, detecting the position of the pointing body on the basis of an electric potential of the specified detection electrode or on the basis of electric potentials of the specified detection electrodes, and displaying an image of a fixed luminance level on a display area of the liquid crystal panel, which overlaps the detection electrode or detection electrodes specified. According to the above aspect of the invention, during a period when the electric potential of the specified detection electrode or the electric potentials of the specified detection electrodes are detected, it is possible to fix the electric potentials of the first electrode and second electrode. In this manner, it is possible to suppress a variation in electric potential of each detection electrode in accordance with a variation in luminance level, a position of the pointing body may be accurately detected.

### BRIEF DESCRIPTION OF THE DRAWINGS

The invention will be described with reference to the accompanying drawings, wherein like numbers reference like elements.

FIG. 1A and FIG. 1B are exploded perspective views, each of which shows a configuration of a liquid crystal device according to an embodiment of the invention.

FIG. 2 is a cross-sectional view that shows a mechanical configuration of the liquid crystal device.

FIG. 3 is a plan view that shows an embodiment of detection electrodes that detect a position of a pointing body in an X direction.

FIG. 4 is a plan view that shows an embodiment of detection electrodes that detect a position of a pointing body in a Y direction.

FIG. 5 is a block diagram that shows an electrical configuration of the liquid crystal device.

FIG. 6 is a view that illustrates a relationship between selection of the detection electrodes and black display.

FIG. 7 is a view that illustrates a relationship between selection of the detection electrodes and black display.

FIG. 8 is a block diagram that shows an electrical configuration of elements that identify a position of the pointing body.

FIG. 9 is a view that illustrates a relationship between selections of both detection electrodes and detection electrodes and black display according to an alternative embodiment.

FIG. 10 is a view that illustrates a relationship between selection of detection electrodes and black display according to an alternative embodiment.

FIG. 11 is a view that illustrates a relationship between selection of detection electrodes and black display according to an alternative embodiment.

FIG. 12 is a view that illustrates a relationship between selections of both detection electrodes and detection electrodes and black display according to an alternative embodiment.

FIG. 13 is a perspective view that shows an embodiment (personal computer) of an electronic apparatus according to the invention.

FIG. 14 is a perspective view that shows an embodiment (cellular phone) of an electronic apparatus according to the invention.

FIG. 15 is a perspective view that shows an embodiment (personal digital assistants) of an electronic apparatus according to the invention.

### DESCRIPTION OF EXEMPLARY EMBODIMENTS

### 1. Embodiment

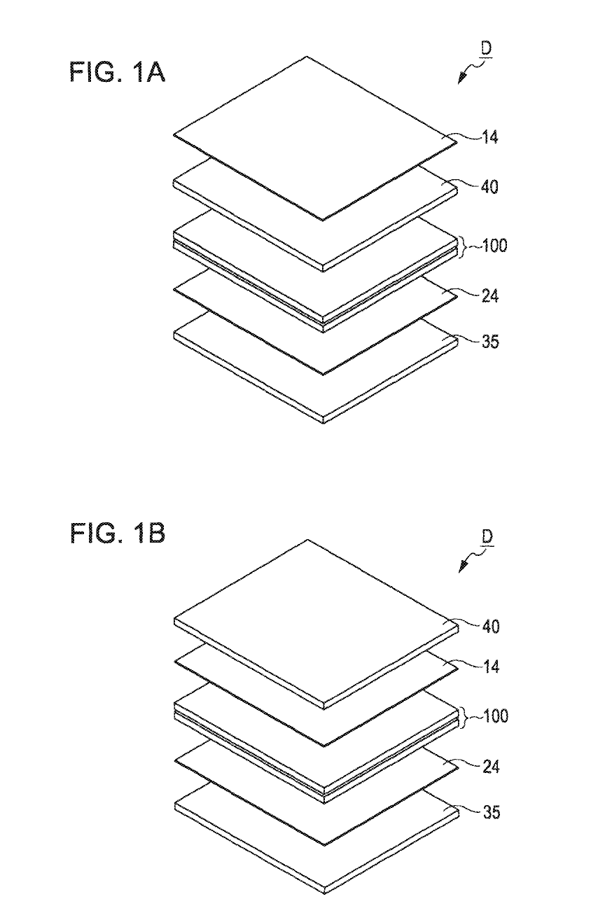

FIG. 1A and FIG. 1B are exploded perspective views, each of which shows a configuration of a liquid crystal device according to an embodiment of the invention. The liquid crystal device D is an electrostatic-capacitance-type touch panel liquid crystal display device that has a function of displaying an image by means of optical action of a liquid crystal and a function of detecting a position of a pointing body (finger or pen) that is in contact with or is in proximity to the front face of the liquid crystal device D in response to a variation in electrostatic capacitance. As shown in FIG. 1A, the liquid crystal device D includes a liquid crystal panel 100 and a touch panel 40. A polarizer 14 is provided on the upper surface of the touch panel 40 and a polarizer 24 is provided on the lower surface of the liquid crystal panel 100. Moreover, a backlight 35 is provided below the polarizer 24. Then, light emitted from the backlight 35 is optically modulated by the liquid crystal panel 100. Note that the liquid crystal device D may be configured so that, as shown in FIG. 1B, the touch panel 40 is interchanged with the polarizer 14.

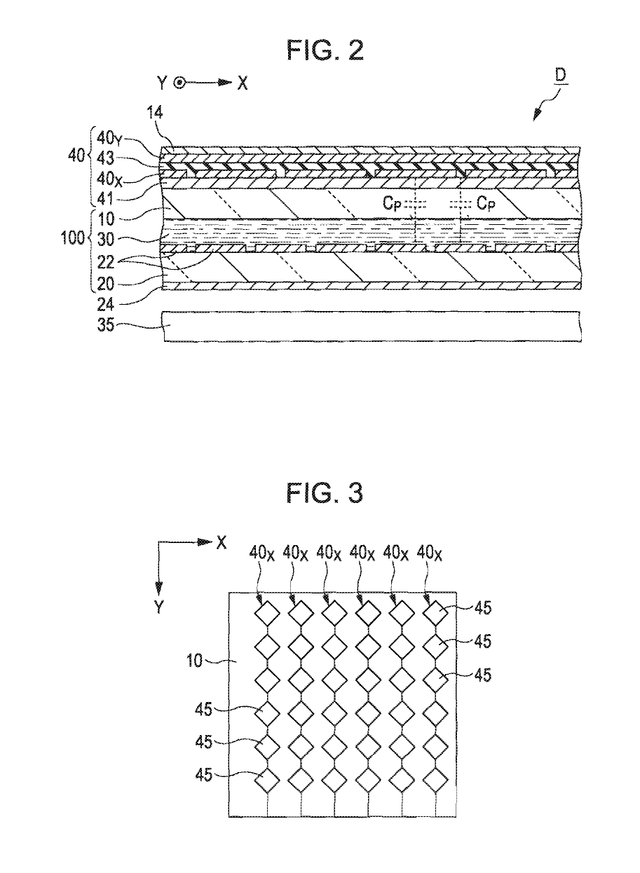

FIG. 2 is a cross-sectional view that shows a configuration of the liquid crystal device D. The liquid crystal panel 40 is formed so that a liquid crystal 30 is sealed in a gap between a first substrate 10 and a second substrate 20, which are opposed to each other. The first substrate 10 and the second substrate 20 are optically transparent plate materials. The first substrate 10 is located on the viewing side (user side) of the liquid crystal device D. Note that, in FIG. 1A and FIG. 1B, an alignment layer and a seal material are not shown.

A plurality of pixel electrodes 22 are formed on a surface of the second substrate 20, which is opposite the first substrate 10, and are spaced apart from one another. Furthermore, a plurality of data lines, a plurality of scanning lines and a plurality of pixels that are arranged at positions corresponding to intersections of the scanning lines and the data lines are provided on the second substrate 20. In each of the pixels, a thin-film transistor (hereinafter, referred to as “TFT”, and not shown in the drawing) is arranged between the pixel electrode 22 and the data line. Each TFT functions as a switching element, and, when the corresponding scanning line is selected to enter an on state, a voltage supplied from the data line is written to the pixel electrode 22. Because the TFTs and various wirings are formed on the second substrate 20, the second substrate 20 may also be called as an element substrate, and the first substrate 10 may be called as an opposite substrate. In addition, the liquid crystal panel 100 of the present embodiment is configured so that an opposite electrode is not formed on the surface of the first substrate 10, which is opposite the second substrate 20. Therefore, an IPS (in-plane switching) mode in which a voltage is applied to the liquid crystal in a lateral direction is employed, and alignment of the liquid crystal is varied on the basis of a voltage applied between the adjacent pixel electrodes 22.

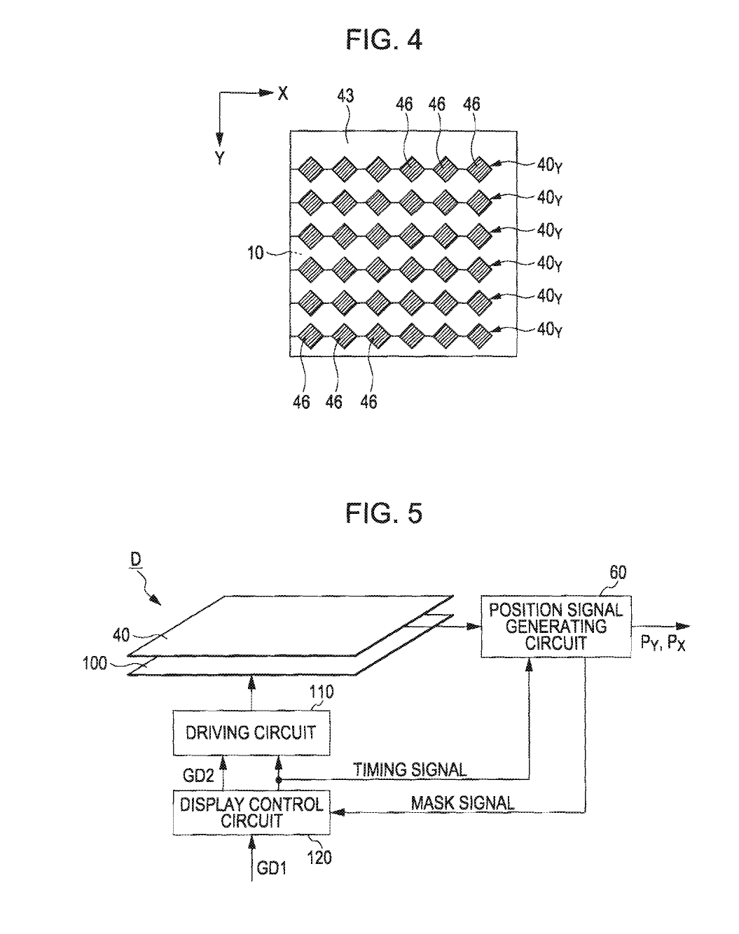

As shown in FIG. 2, the touch panel 40 is configured so that a plurality of detection electrodes 40Y, an insulating layer 43 and a plurality of detection electrodes 40Y are laminated on a transparent substrate 41. FIG. 3 is a view that shows an embodiment of the plurality of detection electrodes 40X. FIG. 4 is a view that shows an embodiment of the plurality of detection electrodes 40Y. FIG. 3 and FIG. 4 are plan views as viewed from the viewing side (upper side) of FIG. 1. Note that the plurality of detection electrodes 40Y are shown with diagonal lines for the sake of convenience. In addition, hereinafter, a configuration that is provided with six detection electrodes 40X and six detection electrodes 40Y is exemplified for the sake of convenience; however, the number of detection electrodes 40X and the number of detection electrodes 40Y may be selected. The number of detection electrodes 40X may be different from the number of detection electrodes 40Y.

The plurality of detection electrodes 40X are elongated conductive films that are formed on the surface of the first substrate 10 and arranged parallel with one another in an X direction. The detection electrodes 40X are used to detect a position of the pointing body in the X direction. As shown in FIG. 3, each of the detection electrodes 40X is a conductive film that connects a plurality of electrodes 45 arranged in the Y direction with one another. As shown in FIG. 1, the insulating layer 43 is an optically transparent film that coats the plurality of detection electrodes 40X over the entire area of the first substrate 10. The plurality of detection electrodes 40Y are elongated conductive films that are arranged parallel with one another in the Y direction and are used to detect a position of the pointing body in the Y direction. The plurality of detection electrodes 40Y are formed on the surface of the insulating layer 43. Thus, each of the detection electrodes 40X and each of the detection electrodes 40Y are electrically insulated by the insulating layer 43. Each of the detection electrodes 40X and each of the detection electrodes 40Y are formed of optically transparent conductive material (for example, ITO (Indium Tin Oxide)).

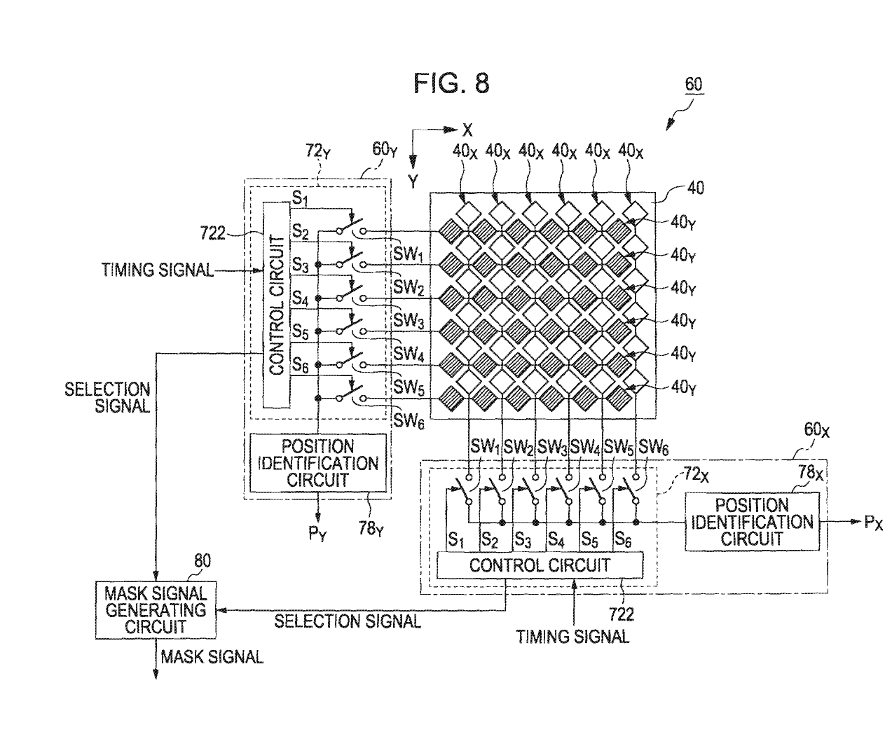

As shown in FIG. 4, each of the detection electrodes 40Y is a conductive film that connects a plurality of electrodes 46 that are arranged in the X direction with one another. As shown in FIG. 8, electrodes 45 of each detection electrode 40X and electrodes 46 of each detection electrode 40Y are arranged so as not to overlap each other as viewed in a direction perpendicular to the first substrate 10. As shown in FIG. 2, both the detection electrodes 40X and the detection electrodes 40Y are opposed to the pixel electrodes 22 through the first substrate 10. Thus, capacitances (parasitic capacitances) CP are formed between the detection electrodes 40X and the pixel electrodes 22 and between the detection electrodes 40Y and the pixel electrodes 22.

Each of the pixel electrodes 22 is supplied with a voltage corresponding to a gray-scale level to be displayed. As described above, because the pixel electrodes 22 are capacitively coupled to the detection electrodes 40X and the detection electrodes 40Y with the parasitic capacitances CP, when the electric potentials of the pixel electrodes 22 vary, the electric potentials of the detection electrodes 40X and the electric potentials of the detection electrodes 40Y also vary. This causes noise. In the liquid crystal device of a type in which opposite electrodes are formed on the first substrate 10, because the opposite electrodes function as a shield, variations in electric potentials of the pixel electrodes 22 cause noise to a lesser degree to be superposed on the electric potentials of the detection electrodes 40X and the electric potentials of the detection electrodes 40Y. However, in the liquid crystal device D of the present embodiment, in which opposite electrodes are not formed on the first substrate 10, large noise is superposed on the electric potentials of the detection electrodes 40X and the electric potentials of the detection electrodes 40Y. In the liquid crystal device D of the present embodiment, an image immediately below the detection electrodes 40X and/or the detection electrodes 40Y, which are used to detect a position of the pointing body, is, for example, displayed with solid black. Then, the electric potentials of the pixel electrodes 22 are fixed to electric potentials corresponding to a black level, so that no noise electric potential is induced in the detection electrodes 40X and the detection electrodes 40Y.

FIG. 5 is a view that shows an electrical configuration of the liquid crystal device D. A driving circuit 110 includes a scanning line driving circuit and a data line driving circuit. The scanning line driving circuit outputs scanning signals for sequentially selecting the plurality of scanning lines of the liquid crystal panel 100. The data line driving circuit supplies the plurality of data lines of the liquid crystal panel 100 with voltages corresponding to gray-scale levels to be displayed. A display control circuit 120 supplies the driving circuit 110 and a position signal generating circuit 60 with various timing signals. The timing signals include, for example, a Y clock signal for driving the scanning line driving circuit and a Y transfer start pulse that instructs a start of transfer in the Y direction, and an X clock signal for driving the data line driving circuit and an X transfer start pulse that instructs a start of transfer in the X direction.

The position signal generating circuit 60 sequentially selects the plurality of detection electrodes 40X and the plurality of detection electrodes 40Y in synchronization with a timing signal and detects an electric potential of the selected electrode. Thus, a position at which the pointing body is in contact with the touch panel 40 is identified to generate a position signal PX and a position signal PY. Furthermore, the position signal generating circuit 60 also generates a mask signal that specifies a display area of the liquid crystal panel 100, which is located immediately below the selected target electrodes, and outputs the mask signal to the display control circuit 120. The display control circuit 120, in the display area specified by the mask signal, generates output image data GD2, for which the luminance level of input image data GD1 is set to a fixed level, and supplies the output image data GD2 to the driving circuit 110. In this example, the fixed level is set to a black level. This is because it is unrecognizable when being set to a black level. In this manner, a noise electric potential that is superposed on the detection electrodes 40X and on the detection electrodes 40Y is largely reduced, so that reliability of the position signals PX and PY may be improved.

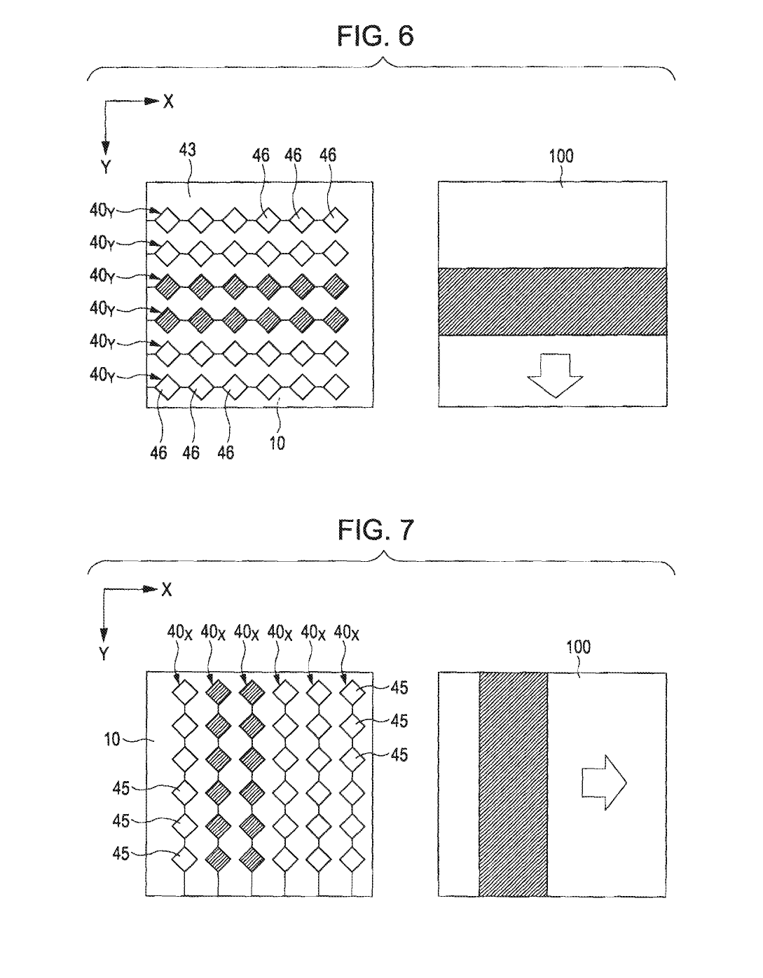

With reference to FIG. 6 and FIG. 7, a relationship between selections of both the detection electrodes 40X and the detection electrodes 40Y and black display is shown. The area of black display may be formed in a band and scrolled while the position of black display is shifted every writing period of a voltage applied to the liquid crystal. For example, as shown in FIG. 6, when the detection electrodes 40Y are controlled, it is only necessary to scroll a band extending in a horizontal direction, while, when the detection electrodes 40X are controlled, it is only necessary to scroll a band extending in a vertical direction as shown in FIG. 7. For example, when the third and fourth detection electrodes 40Y in order from the upper side are sequentially selected during a certain frame, as shown on the right side in FIG. 6, a display area corresponding to the third and fourth detection electrodes 40Y are set to black display.

FIG. 8 is a block diagram that shows a specific configuration of elements that identify a position of the pointing body. As shown in the drawing, the position signal generating circuit 60 includes a position signal generating circuit 60X, a position signal generating circuit 60Y and a mask signal generating circuit 80. The position signal generating circuit 60X detects a position of the pointing body in the X direction using the plurality of detection electrodes 40X. The position signal generating circuit 60Y detects a position of the pointing body in the Y direction using the plurality of detection electrodes 40Y. The position signal generating circuit 60X includes a switching circuit 72X and a position identification circuit 78X. Similarly, the position signal generating circuit 60Y includes a switching circuit 72Y and a position identification circuit 78Y. As described above, because the position signal generating circuit 60X and the position signal generating circuit 60Y have the same configurations, in the following description, the configuration and operation of both the position signal generating circuit 60X and the position signal generating circuit 60Y will be described together using a reference sign K (K=X, Y) that represents both of them.

The switching circuit 72K shown in FIG. 8 functions as a device to sequentially select the six detection electrodes 40K. The switching circuit 72K of the present embodiment is provided with six switches SW1 to SW6 corresponding to the number of the detection electrodes 40K and a control circuit 722 that generates selection signals S1 to S6 for controlling the corresponding switches SW1 to SW6. The control circuit 722 sequentially sets the selection signals S1 to S6 to a high level (active) at predetermined intervals. For example, the switching circuit 72Y sequentially sets the selection signals S1 to S6 to a high level during the corresponding first to sixth frames, and the switching circuit 72X sequentially sets the selection signals S1 to S6 to a high level during the corresponding seventh to twelfth frames. In this case, scanning of the detection electrodes 40K is completed for a period of twelve frames.

The position identification circuit 78K, when the selection signals S1 to S6 switch from a low level to a high level, applies an initialization electric potential to the selected detection electrode 40K just during a predetermined period of time. After that, the position identification circuit 78K internally connects the selected detection electrode 40K to a resistance of which one end is grounded, and monitors an electric potential of the above connected point as a detection signal. Each of the detection electrodes 40K is associated with a parasitic capacitance, so that an electric potential of each connected point varies on the basis of a time constant that is determined by a capacitance value and a resistance value of each detection electrode 40K.

Here, when the pointing body is placed on the selected detection electrode 40K, a capacitance is generated between the selected detection electrode 40K and the pointing body. Where this capacitance value is CX, the capacitance value that is associated with the detection electrode 40K varies from the parasitic capacitance CP to the capacitance CP+CX. Thus, the time constant between the detection electrode 40K and the resistance varies. When an initialization period is defined as a period during which an initialization electric potential is applied to each of the detection electrodes 40K and a detection period is defined as a period subsequent to the initialization period, the position identification circuit 78K monitors a detection signal (an electric potential of the connected point) during the detection period. At this time, the detection signal varies from the initialization electric potential to a ground electric potential in accordance with the time constant. Specifically, when the pointing body is placed on or above the detection electrode 40K, the time constant increases, so that the detection signal gradually varies. The position identification circuit 78K, during the detection period, compares the detection signal with a reference electric potential that is set between the initialization electric potential and the ground electric potential, and determines whether the time that has elapsed since the start of the detection period until the reference electric potential coincides with the detection signal exceeds a predetermined reference time. Then, when the time exceeds the reference time, it is determined that the pointing body is placed on or above the detection electrode 40K, and the position identification circuit 78K generates position signals PX and PY that indicate the position coordinate of the detection electrode 40K.

Each of the control circuits 722 supplies a selection signal that indicates the selected detection electrode 40K to the mask signal generating circuit 80. The mask signal generating circuit 80 generates a mask signal that specifies the selected detection electrode 40K on the basis of the selection signal supplied from the position signal generating circuits 60X and 60Y. As described above, the display control circuit 120, in the display area specified by the mask signal, generates the output image data GD2 for which the luminance levels of the input image data GD1 are set to a fixed level. Thus, during the initialization period and the detection period, the electric potential of the pixel electrode 22 located immediately below the selected detection electrode 40K does not vary. In this manner, it is possible to accurately detect an electric potential of the connected point, and also it is possible to greatly improve reliability of the position signals PX and PY.

### 2. Alternative Embodiment

(1) In the above described embodiment, the switching circuit 72K is configured to select one detection electrode 40K every frame; however, the switching circuit 72K may be configured to select the plurality of detection electrodes 40K every frame. For example, the switching circuit 72Y may be configured to sequentially set the selection signals S1 and S2 to a high level in a first frame, sequentially set the selection signals S3 and S4 to a high level in a second frame, and sequentially set the selection signals S5 and S6 to a high level in a third frame, and the switching circuit 72X may be configured to sequentially set the selection signals S1 and S2 to a high level in a fourth frame, sequentially set the selection signals S3 and S4 to a high level in a fifth frame, and sequentially set the selection signals S5 and S6 in a sixth frame. In this case, the mask signal generating circuit 80 generates a mask signal that specifies a display area of the liquid crystal panel 100, which is located immediately below the two detection electrodes 40K, and outputs the mask signal to the display control circuit 120.

In addition, the switching circuit 72K may be configured to scan six detection electrodes 40K in one frame. For example, the switching circuit 72Y may be configured to sequentially set the selection signals S1 to S6 to a high level in a first frame, and the switching circuit 72X may be configured to sequentially set the selection signals S1 to S6 to a high level in a second frame. However, the position identification circuit 78K executes a process to identify a position of the pointing body for one detection electrode 40K per frame. That is, the position identification circuit 78K generates position signals PX and PY that indicate a position of the pointing body only on the basis of the detection signal acquired from the detection electrode 40K that is specified in conformity with a predetermined rule among the detection electrodes 40K sequentially selected in the switching circuit 72K. In this case, the mask signal generating circuit 80 generates a mask signal that specifies a display area of the liquid crystal panel 100, which is located immediately below the detection electrode 40K that the position identification circuit 78K uses as an identification target. For example, when the switching circuit 72Y selects the second detection electrode 40Y in order from the upper side in the second frame, the mask signal generating circuit 80 generates a mask signal that specifies a display area of the liquid crystal panel 100, which is located immediately below the second detection electrode 40Y in the second frame. In this case, the position signal generating circuit 60K includes the switching circuit 72K and the position identification circuit 78K. The switching circuit 72K sequentially selects each of the plurality of detection electrodes 40K and outputs a detection signal by detecting an electric potential of each of the sequentially selected detection electrodes 40K. The position identification circuit 78K generates position signals PY and PX that indicate a position of the detection signal acquired from the detection electrode 40K specified in conformity with a predetermined rule among the detection electrodes 40K that are sequentially selected.

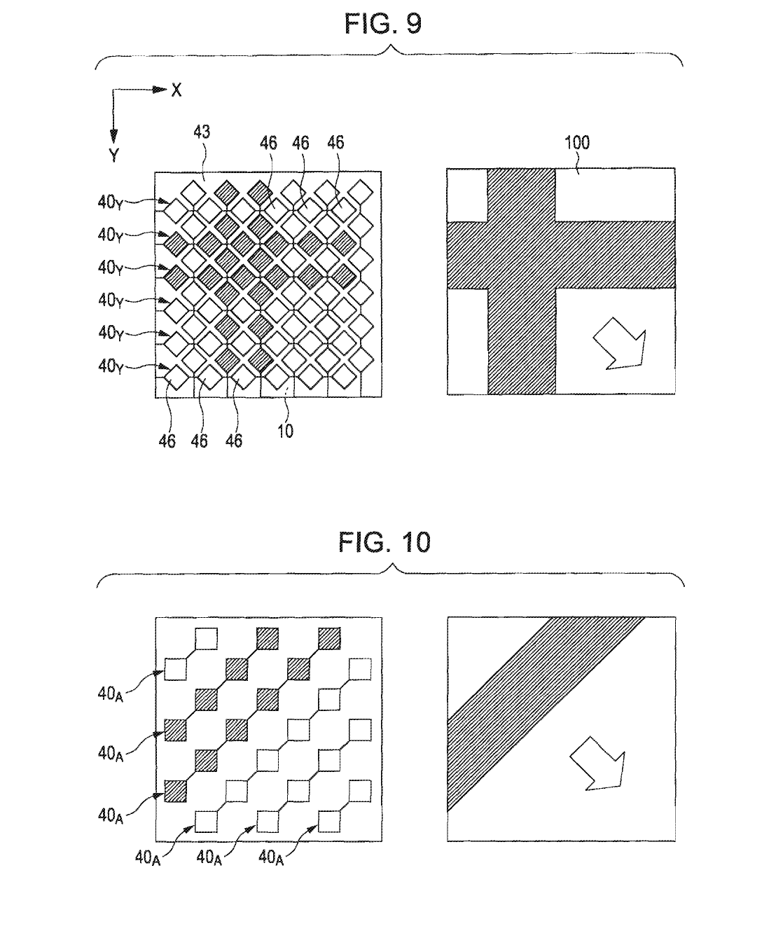

(2) In the above described embodiment, one of the detection electrodes 40Y and 40X is selected; however, both the detection electrodes 40Y and 40X be selected at the same time. In this case, as shown in FIG. 9, the vertical and horizontal bands may be crossed and then scrolled. In this manner, because both the detection electrode 40X and the detection electrode 40Y may be selected at the same time, it is possible to reduce the amount of scanning time for which all the detection electrodes 40K are scanned.

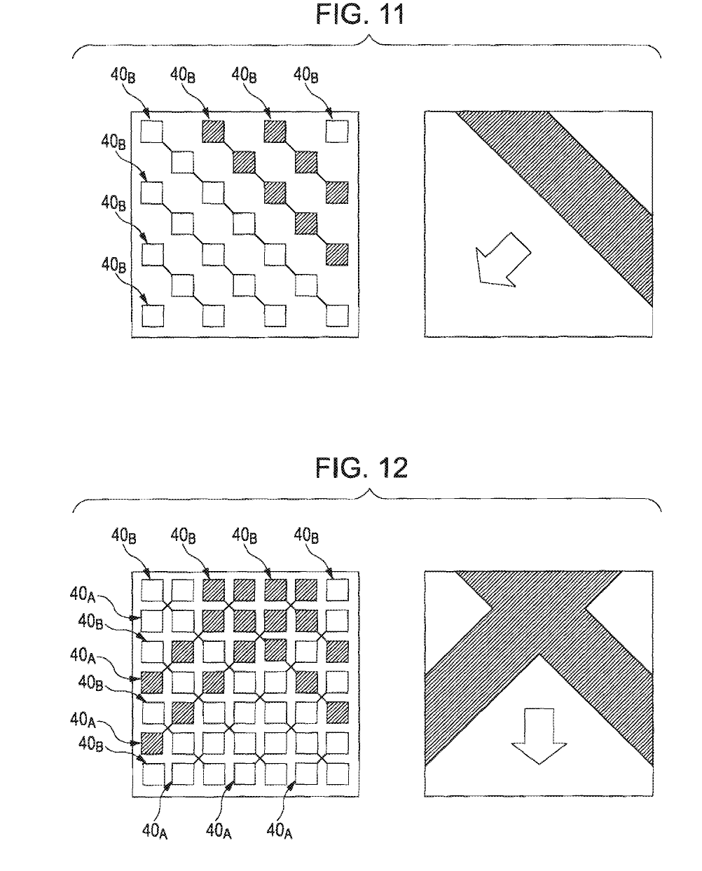

(3) In addition, in the above described embodiment, the detection electrodes 40Y are formed along the X direction as in the case of the scanning lines and the detection electrodes 40X formed along the Y direction as in the case of the data lines; however, the aspects of the invention are not limited to it. Detection electrodes may be formed obliquely to the X direction and the Y direction. For example, detection electrodes 40A shown in FIG. 10 may be used instead of the detection electrodes 40Y, and detection electrodes 40B shown in FIG. 11 may be used instead of the detection electrodes 40X. In this case, the mask signal specifies a display area of an oblique band as shown on the right sides of FIG. 10 and FIG. 11, and the position identification circuit 78K has only to generate detection signals by scrolling these bands. Furthermore, both the detection electrodes 40A and 40B may be selected at the same time. In this case, as shown in FIG. 12, the upward-sloping band and the downward-sloping band are crossed and then scrolled.

(4) An alignment mode of the liquid crystal 30 may be selected. For example, the aspects of the invention may be applied to various liquid crystal devices D that use a TN (Twisted Nematic) mode, a VA (Vertical Alignment) mode, or an ECB (Electrically Controlled Birefringence) mode. In addition, opposite electrodes may be formed on the first substrate 10. Moreover, the aspects of the invention may also be applied to a liquid crystal device, such as an FFS (Fringe Field Switching) mode liquid crystal device, in which opposite electrodes are formed on the side of the second substrate 20.

(5) In the above described embodiment and alternative embodiments, the band of black display is scrolled and the electric potentials of the detection electrodes 40X, 40Y, 40A, and 40B corresponding to black display are detected; however, the aspects of the invention are not limited to it. It may be configured so that the fixed luminance level is used to display an entire screen every predetermined number of frames (for example, once per 60 frames) and, in the frame, the detection electrodes 40X, 40Y, 40A, and 40B are sequentially selected to generate position signals PX and PY. In this case, the mask signal is active during a frame period when the fixed luminance level is used to display a screen. Alternatively, it may be configured so that the display control circuit 120 supplies the position signal generating circuit 60 with a control signal that specifies a frame in which the detection electrodes 40X, 40Y, 40A, and 40B are scanned, and, in the frame, the levels indicated by the output image data GD2 are set to a fixed luminance level. In this case, the position signal generating circuit 60, in the frame specified by the control signal, scans the detection electrodes 40X, 40Y, 40A, and 40B to generate position signals PX and PY.

Note that the fixed luminance level may be a black level or may be a level that is obtained in such a manner that the average value of the luminance levels of the entire screen in the preceding frame relative to the scanning target frame is calculated by the display control circuit 120. In the latter case, it is more difficult for a user to view it. The more the number of times the position signal PX or PY is generated per unit time, the response characteristic of the touch panel 40 may be improved; however, it is necessary to display the fixed luminance level in order to generate the position signal PX or PY. That is, there is a trade-off relationship between the response characteristic of the touch panel 40 and visibility in which a user recognizes an image unnatural. Because the visibility may be improved by setting the average value as the fixed luminance level, the number of times the position signal PX or PY is Generated per unit time is increased, so that the response characteristic of the touch panel 40 may be improved.

### 3. Application Examples

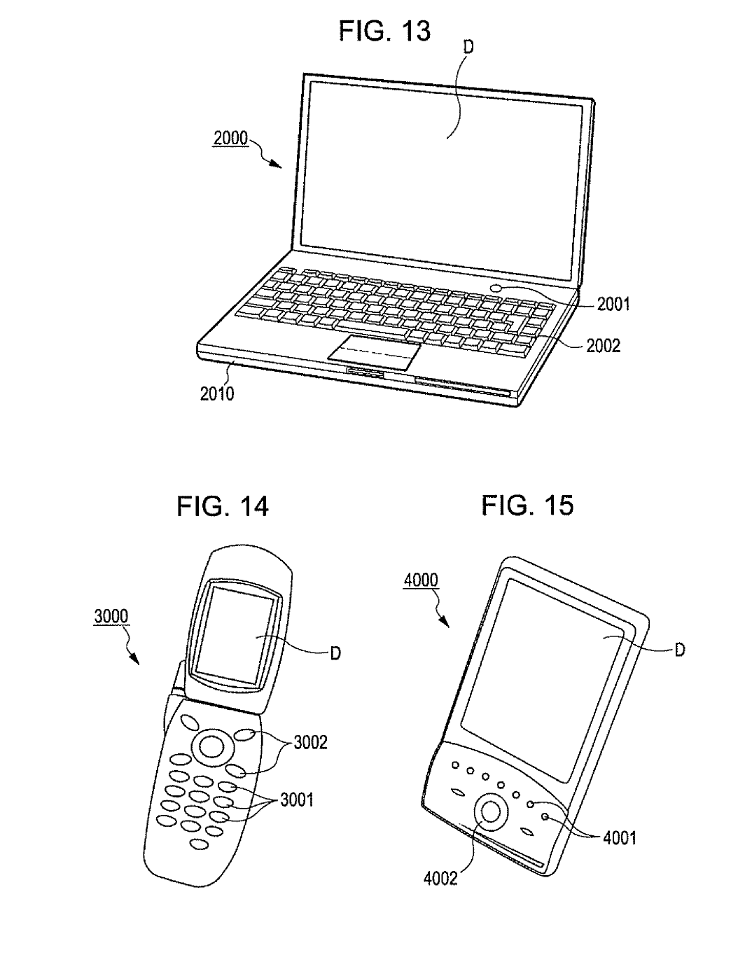

Next, electronic apparatuses that use the liquid crystal device according to the aspects of the invention will be described. FIG. 13 to FIG. 15 are views that show embodiments of electronic apparatuses that use the liquid crystal device D according to any one of the embodiments described above as a display device. FIG. 13 is a perspective view that shows a configuration of a mobile personal computer that uses the liquid crystal device D. The personal computer 2000 includes the liquid crystal device D that displays various images and a body portion 2010 in which a power switch 2001 and a keyboard 2002 are installed. FIG. 14 is a perspective view that shows a configuration of a cellular phone that uses the liquid crystal device D. The cellular phone 3000 includes a plurality of operation buttons 3001, a plurality of scroll buttons 3002, and the liquid crystal device D that displays various images. By manipulating the scroll buttons 3002, a screen displayed on the liquid crystal device D will be scrolled. FIG. 15 is a perspective view of a configuration of a personal digital assistants (PDA) to which the liquid crystal device D is applied. The personal digital assistants 4000 includes a plurality of operation buttons 4001, a power switch 4002 and the liquid crystal device D that displays various images. As the power switch 4002 is manipulated, various pieces of information, such as an address book and a schedule book, are displayed on the liquid crystal device D. Note that the electronic apparatuses that employ the liquid crystal device according to the aspects of the invention include, in addition to the apparatuses shown in FIG. 13 to FIG. 15, a digital still camera, a television, a video camera, a car navigation system, a pager, an electronic personal organizer, an electronic paper, an electronic calculator, a word processor, a workstation, a video telephone, a POS terminal, a printer, a scanner, a photocopier, and a video player.

What is claimed is:

1. A liquid crystal device comprising:
a liquid crystal panel that is formed so that a liquid crystal is sealed in a gap between an element substrate and an opposite substrate, which are opposed to each other, and a transmittance ratio of the liquid crystal is controlled on the basis of a voltage applied between a first electrode and a second electrode;
a touch panel that is arranged on a side of the opposite substrate and provided with a plurality of detection electrodes;
a position signal generating device that specifies one or plurality of the plurality of detection electrodes in conformity with a predetermined rule and that generates a position signal that indicates a position of a pointing body on the basis of an electric potential of the specified detection electrode or on the basis of electric potentials of the specified detection electrodes; and
a display control device that displays an image of a fixed luminance level on a display area of the liquid crystal panel, which overlaps the detection electrode or detection electrodes specified by the position signal generating device.

2. The liquid crystal device according to claim 1, wherein the first electrode and the second electrode are formed on the element substrate.

3. The liquid crystal device according to claim 1, wherein the position signal generating device includes:
a selection device that selects each of the plurality of detection electrodes;
a detection device that outputs a detection signal by detecting an electric potential of the detection electrode or detection electrodes selected by the selection device; and
a position identification device that generates a position signal that indicates a position of the pointing body on the basis of the detection signal, wherein
the display control device determines the detection electrode or detection electrodes selected by the selection device as a detection electrode or detection electrodes specified, and displays an image of a fixed luminance level on a display area of the liquid crystal panel, which overlaps the specified detection electrode.

4. The liquid crystal device according to claim 1, wherein the position signal generating device includes:
a selection device that sequentially selects each of the plurality of detection electrodes;
a detection device that detects an electric potential of the detection electrode or detection electrodes sequentially selected by the selection device, and that outputs a detection signal; and
a position identification device that generates a position signal that indicates a position of the pointing body on the basis of the detection signal acquired from the detection electrode or detection electrodes specified in conformity with the predetermined rule among the detection electrodes sequentially selected by the selection device.

5. The liquid crystal device according to claim 1, wherein the plurality of detection electrodes include a plurality of first detection electrodes that are formed parallel to a first direction and a plurality of second detection electrodes that are formed parallel to a second direction that intersects with the first direction.

6. The liquid crystal device according to claim 5, further comprising:
a plurality of scanning lines;
a plurality of data lines;
a plurality of pixels that are provided at positions corresponding to intersections of the scanning lines and the data lines, wherein the plurality of scanning lines, the plurality of data lines and the plurality of pixels are formed on the element substrate; and
a driving device that is provided to write a voltage, corresponding to a gray-scale level to be displayed, to a pixel corresponding to a selected one of scanning lines through the a corresponding one of the data lines, wherein
the first direction is the same direction as a direction in which the plurality of scanning lines are formed, and wherein
the second direction is the same direction as a direction in which the plurality of data lines are formed.

7. The liquid crystal device according to claim 5, further comprising:
a plurality of scanning lines;
a plurality of data lines;
a plurality of pixels that are provided at positions corresponding to intersections of the scanning lines and the data lines, wherein the plurality of scanning lines, the plurality of data lines and the plurality of pixels are formed on the element substrate; and
a driving device that is provided to write a voltage, corresponding to a gray-scale level to be displayed, to a pixel corresponding to a selected one of the scanning lines through the a corresponding one of the data lines, wherein
the first direction and the second direction are oblique directions to a direction in which the plurality of scanning lines are formed.

8. An electronic apparatus comprising the liquid crystal device according to claim 1.

9. A method of detecting a position of a pointing body in a liquid crystal device that includes a liquid crystal panel and a touch panel, wherein the liquid crystal panel is formed so that a liquid crystal is sealed in a gap between an element substrate and an opposite substrate, which are opposed to each other, and a transmittance ratio of the liquid crystal is controlled on the basis of a voltage applied between a first electrode and a second electrode, wherein the touch panel is arranged on a side of the opposite substrate and provided with a plurality of detection electrodes, the method comprising:
specifying one or plurality of the plurality of detection electrodes in conformity with a predetermined rule;
detecting the position of the pointing body on the basis of an electric potential of the specified detection electrode or on the basis of electric potentials of the specified detection electrodes; and
displaying an image of a fixed luminance level on a display area of the liquid crystal panel, which overlaps the detection electrode or detection electrodes specified.
